(19) United States
(12) Patent Application Publication
(10) Pub. No.: US 2025/0340121 A1
(43) Pub. Date: Nov. 6, 2025

(54) REFUSE VEHICLE WITH ENERGY HARVESTING SYSTEM

(71) Applicant: Oshkosh Corporation, Oshkosh, WI (US)

(72) Inventor: Jacob Wallin, Oshkosh, WI (US)

(73) Assignee: Oshkosh Corporation, Oshkosh, WI (US)

(21) Appl. No.: 19/197,674

(22) Filed: May 2, 2025

Related U.S. Application Data
(60) Provisional application No. 63/642,049, filed on May 3, 2024.

(51) Int. Cl. B60L 1/00

(52) U.S. Cl. CPC B60L 1/20; B60L 1/003; B60L 2200/40

(57) ABSTRACT

A refuse vehicle includes a chassis, a body assembly coupled to the chassis, an energy storage system supported by the chassis, an energy harvesting system coupled to the energy storage system, a first component coupled to the energy harvesting system, and a second component coupled to the energy harvesting system. The body assembly defines a refuse compartment for storing refuse therein. The energy harvesting system is configured to operate the first component to transition from a first state to a second state using energy from the energy storage system, harvest return energy from the first component returning to the first state from the second state, and operate the second component using the return energy. The energy harvesting system may include an electric power take-off (E-PTO). At least one of the first component or the second component may be a hydraulic component or an electromechanical component.

### CROSS-REFERENCE TO RELATED PATENT APPLICATIONS

This application claims the benefit of and priority to U.S. Provisional Patent Application No. 63/642,049, filed May 3, 2024, the entire contents of which are hereby incorporated by reference herein.

### BACKGROUND

Refuse vehicles collect a wide variety of waste, trash, and other material from residences and businesses. Operators of the refuse vehicles transport the material from various waste receptacles within a municipality to a storage or processing facility (e.g., a landfill, an incineration facility, a recycling facility, etc.).

### SUMMARY

One embodiment relates to a refuse vehicle including a chassis and a body assembly coupled to the chassis, the body assembly defining a refuse compartment for storing refuse therein. The refuse vehicle further includes an energy storage system supported by the chassis, an energy harvesting system coupled to the energy storage system, a first component coupled to the energy harvesting system, and a second component coupled to the energy harvesting system. The energy harvesting system is configured to: operate the first component to transition from a first state to a second state using energy from the energy storage system, harvest return energy from the first component returning to the first state from the second state, operate the second component using the return energy.

Another embodiment relates to a method of operating a refuse vehicle. The method includes receiving, by a controller of an energy harvesting system coupled to a vehicle body of a refuse vehicle, energy from an energy storage system coupled to a chassis of the refuse vehicle, the vehicle body supported by the chassis and defining a receptable for storing refuse therein, and the energy storage system configured to provide energy to drive at least one of a plurality of wheels that are supported by the chassis. The method further includes operating, with the energy, a first component coupled to the chassis from a first state to a second state using the energy harvesting system. The method further includes harvesting return energy from the first component returning to the first state from the second state using the energy harvesting system, and operating, with the return energy, a second component coupled to the chassis.

Another embodiment relates to a refuse vehicle including a chassis and a body assembly coupled to the chassis, the body assembly defining a refuse compartment for storing refuse therein. The refuse vehicle further includes an energy storage system supported by the chassis, an energy harvesting system coupled to the energy storage system and comprising a motor/generator, a first component coupled to the motor/generator, wherein the first component is at least one of a first electromechanical component or a first hydraulic component, an electric load coupled to the motor/generator. The energy harvesting system is configured to: operate, via the motor/generator, the first component to transition from a first state to a second state using energy from the energy storage system; resist, via the motor/generator, the first component returning to the first state from the second state to generate return energy; and provide the return energy to the electric load, wherein the return energy does not pass through the energy storage system.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a refuse vehicle, according to an exemplary embodiment;

FIG. 2 is a schematic of a control system of the refuse vehicle of FIG. 1, according to an exemplary embodiment;

FIG. 3 is an expanded schematic of a control system of the refuse vehicle of FIG. 1, according to an exemplary embodiment;

FIG. 4 is a flow chart depicting a method of harvesting return energy from hydraulic fluid in the refuse vehicle of FIG. 1, according to an exemplary embodiment.

FIG. 5 is a flow chart depicting a method of harvesting return energy from hydraulic fluid by diverting the fluid, according to an exemplary embodiment;

FIG. 6 is a schematic view of a control system of the refuse vehicle of FIG. 1, according to an exemplary embodiment; and

FIG. 7 is a flow chart depicting a method of harvesting return energy in the refuse vehicle of FIG. 1, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

According to an exemplary embodiment, a regenerative energy harvesting or energy recovery system (referred to herein as an energy harvesting system) for a refuse vehicle is disclosed herein. The energy harvesting system of the present disclosure provides many advantages over refuse vehicles without an energy harvesting system and over conventional energy harvesting systems. In conventional refuse vehicles, excess energy may be dissipated by resistors which ‘burn off’ the heat, resulting in wasted energy. In conventional energy harvesting systems, regenerative energy is captured from a limited number of systems (e.g., regenerative braking systems) and the return energy may be passed back into an onboard energy storage system, resulting in conversion losses and the requirement for complicated and expensive internal wiring. The energy harvesting system of the present disclosure may generate return energy (i.e., recovered energy, harvested energy) by returning, slowing, or resisting one or more components in addition to or alternatively to the braking system of the refuse vehicle and providing the return energy to another component of the refuse vehicle without the need to pass the return energy through an onboard energy storage system.

The energy harvesting system may generate return energy from both hydraulically- powered components and electrically-powered components. For hydraulically-powered components, the energy harvesting system may include a controller and one or more valves for diverting hydraulic fluid flow. In such embodiments, a return flow may be harvested by diverting the return flow to power other hydraulic functions and/or components (e.g., low-load components) or to an accumulator. An energy harvesting system may additionally and/or alternatively include one or more E-PTOs for converting hydraulic energy into electricity. The return flow may diverted to run a hydraulic pump/motor of the E-PTO to generate return energy in the form of electricity. In such cases, harvesting return energy includes transforming the hydraulic energy of the return flow into electric energy using the E-PTO. For electrically-powered components, an energy harvesting system may include an electric motor/generator. The electric motor/generator may be coupled to a component and configured to (i) operate the component and/or (ii) slow/resist the component as the component returns to a stable position or state. Harvesting return energy in such embodiments includes converting the mechanical energy from slowing/resisting the component into electric energy via the electric motor/generator. An electric load can be applied to the electric motor/generator which can therefore generate current to power or at least partially power another component or function of the refuse vehicle.

The generated return energy, be it hydraulic or electric, may be passed to one or more other components of the refuse vehicle. The generated return energy may be routed without the return energy passing through an onboard energy storage device (e.g., battery, fuel cell, capacitor, accumulator, etc.). In some refuse vehicles, it may be difficult to deliver the return energy back to an onboard energy storage device such as a battery or a hydrogen system. By avoiding the need to route the return energy back to the onboard energy storage device, the electrical architecture of the refuse vehicle can therefore be simplified and energy losses from conversion can be reduced. The return energy may be used to power low-load functions (or components) and/or non-critical functions (or components) that can be run at selective, optimal times (e.g., a packer, one or more components of a heat management system, etc.). The return energy may be sufficient to completely power a successive operation or function or may at least partially power the successive operation or function. The amount of energy harvested from one component may be determined and mapped to other components where the amount of energy is sufficient to operate the other components.

### Overall Vehicle

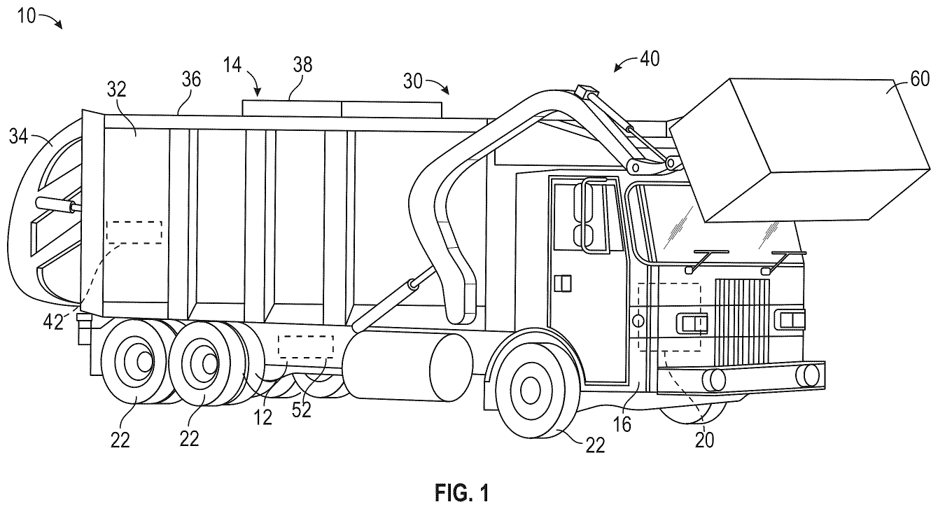

Referring to FIG. 1, a vehicle, shown as refuse vehicle 10 (e.g., garbage truck, waste collection truck, sanitation truck, etc.), includes a chassis, shown as a frame 12; a body assembly, shown as body 14, coupled to the frame 12 (e.g., at a rear end thereof, etc.); and a cab 16, coupled to the frame 12 (e.g., at a front end thereof, etc.). The cab 16 may include various components to facilitate operation of refuse vehicle 10 by an operator (e.g., a seat, a steering wheel, hydraulic controls, a user interface, switches, buttons, dials, etc.). The cab 16 may also include components that can execute commands automatically to control different subsystems within the vehicle (e.g., computers, controllers, processors, etc.). The refuse vehicle 10 further includes a prime mover 20 coupled to the frame 12 at a position beneath the cab 16. The prime mover 20 provides power to a plurality of motive members, shown as wheels 22, and to other systems of the vehicle (e.g., a pneumatic system, a hydraulic system, an electric system, etc.). A pair of wheels 22 may be coupled to an axle. The refuse vehicle 10 may include at least two axles. In some embodiments, the refuse vehicle 10 may include at least four axles, and may include five axles in various embodiments herein.

The prime mover 20 may be configured to use a variety of fuels (e.g., gasoline, diesel, biodiesel, ethanol, natural gas, etc.), according to various exemplary embodiments. According to an alternative embodiment, the prime mover 20 includes one or more electric motors coupled to the frame 12. The electric motors may consume electrical power from an onboard storage device (e.g., batteries, ultra-capacitors, etc.), from an onboard generator (e.g., an internal combustion engine, hydrogen fuel cells, high efficiency solar panels, regenerative braking system, etc.), or from an external power source (e.g., overhead power lines) and provide power to the systems of the refuse vehicle 10. According to some embodiments, the refuse vehicle 10 may be in other configurations than shown in FIG. 1.

According to an exemplary embodiment, the onboard energy storage device is configured to (a) receive and/or store power and (b) provide electric power to (i) the electric motor 18 to drive the wheels 22, (ii) electric actuators of the refuse vehicle 10 to facilitate operation thereof (e.g., lift actuators, tailgate actuators, packer actuators, grabber actuators, etc.), (iii) hydraulic pumps of the refuse vehicle 10 to facilitate operation thereof of one or more hydraulic components (e.g., hydraulic pump 58, lift assembly 40, packer system 42, ejector 62, etc.) and/or (iv) electrically operated accessories of the refuse vehicle 10 (e.g., displays, lights, etc.). The onboard energy storage device may include one or more rechargeable batteries (e.g., lithium-ion batteries, nickel-metal hydride batteries, lithium-ion polymer batteries, lead-acid batteries, nickel-cadmium batteries, etc.) such as the battery pack 52, capacitors, solar cells, generators, power buses, etc. The onboard energy storage device may thereby be charged via an onboard generator (e.g., an internal combustion generator, a solar panel system, etc.), from an external power source (e.g., overhead power lines, mains power source through a charging input, etc.), and/or via a power regenerative braking system, and provide power to the electrically operated systems of the refuse vehicle 10. In some embodiments, the energy storage and/or generation system includes a heat management system (e.g., liquid cooling, heat exchanger, air cooling, etc.).

According to an exemplary embodiment, the refuse vehicle 10 is configured to transport refuse from various waste refuse containers within a municipality to a storage or processing facility (e.g., a landfill, an incineration facility, a recycling facility, etc.). The body 14 includes an onboard refuse container. In the embodiment of FIG. 1, the body 14 and onboard refuse container, in particular, defines a collection chamber 24. In some embodiments, the body 14 includes a plurality of panels, shown as panels 32, a tailgate 34, and a cover 36 that together define the collection chamber 24. Loose refuse may be placed into the refuse compartment 30 where it may thereafter be compacted (e.g., by a packer system, etc.). The refuse compartment 30 may provide temporary storage for refuse during transport to a waste disposal site and/or a recycling facility. In some embodiments, at least a portion of the body 14 and the refuse compartment 30 extend above or in front of the cab 16. According to the embodiment shown in FIG. 1, the body 14 and the refuse compartment 30 are positioned behind the cab 16.

In some embodiments, the refuse compartment 30 includes a hopper volume and a storage volume. Refuse may be initially loaded into the hopper volume and thereafter compacted into the storage volume. A compactor, shown as a packer system 42 (e.g., press, compactor, packer, etc.), is positioned within refuse compartment 30. According to an exemplary embodiment, packer system 42 is configured to compact the refuse within the hopper volume of refuse compartment 30 into the storage volume of refuse compartment 30 thereby increasing the carrying capacity of the refuse vehicle 10. In some embodiments, packer system 42 utilizes hydraulic power to compact the refuse from the hopper volume into the storage portion. In some embodiments, the packer system 42 includes a ram (e.g., ejector 62), and actuators, such as hydraulic cylinders. The hydraulic cylinders may be coupled to ejector 62 and a frame member of body 14.

According to an exemplary embodiment, the hopper volume is positioned between the storage volume and the cab 16 (e.g., refuse is loaded into a position of the refuse compartment 30 behind the cab 16 and stored in a position further toward the rear of the refuse compartment 30). In such arrangements, the refuse vehicle 10 may be a front-loading refuse vehicle or a side-loading refuse vehicle. In other embodiments, the storage volume is positioned between the hopper volume and the cab 16. In such embodiments, the refuse vehicle 10 may be a rear-loading refuse vehicle in which refuse is loaded into the vehicle through a tailgate 34 or rear end of the vehicle.

The body 14 further includes a tailgate 34 which is movably (e.g., rotatably, etc.) coupled to the onboard refuse container and is positioned at the rear end of the body 14. The tailgate 34 is configured to pivot about pivot pins positioned along the top surface of the onboard refuse container. In other embodiments, a different connection mechanism may be used to support the tailgate 34 on the body 14.

As shown in FIG. 1, the refuse vehicle 10 includes a lift mechanism/system (e.g., a front-loading lift assembly, etc.), shown as lift assembly 40, coupled to the front end of the body 14. In other embodiments, the lift assembly 40 extends rearward of the body 14 (e.g., a rear-loading refuse vehicle, etc.). In still other embodiments, the lift assembly 40 extends from a side of the body 14 (e.g., a side-loading refuse vehicle, etc.). As shown in FIG. 1, the lift assembly 40 is configured to engage a container (e.g., a residential trash receptacle, a commercial trash receptacle, a container having a robotic grabber arm, etc.), shown as refuse container 60. The lift assembly 40 may include various actuators (e.g., electric actuators, hydraulic actuators, pneumatic actuators, etc.) to facilitate engaging the refuse container 60, lifting the refuse container 60, and tipping refuse out of the refuse container 60 into the hopper volume of the refuse compartment 30 through an opening in the cover 36 or through the tailgate 34. The lift assembly 40 may thereafter return the empty refuse container 60 to the ground. According to an exemplary embodiment, a door, shown as top door 38, is movably coupled along the cover 36 to seal the opening thereby preventing refuse from escaping the refuse compartment 30 (e.g., due to wind, bumps in the road, etc.).

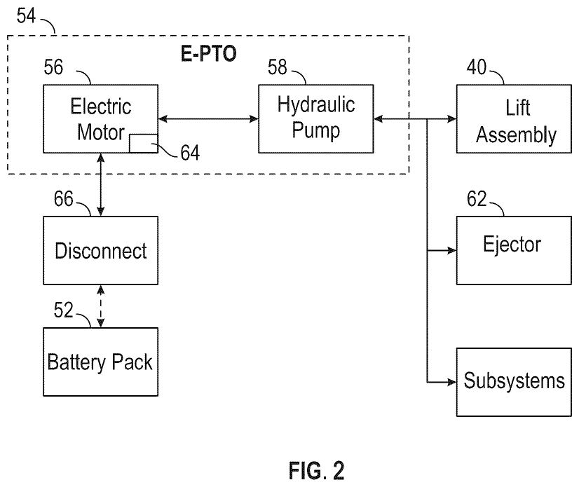

Referring to FIG. 2, in embodiments in which the refuse vehicle is an electric refuse vehicle (e.g., an E-refuse vehicle, etc.) or a hybrid refuse vehicle (e.g., a vehicle including both electric and hydraulic power systems, a vehicle including both electric and hydrogen systems, etc.), the refuse vehicle may further include an onboard energy storage device. In some embodiments, the onboard energy storage device includes a battery pack 52 that provides power to a motor that produces rotational power to drive the refuse vehicle. The energy storage device can be used to provide power to different subsystems on the refuse vehicle. The refuse vehicle may also include an electric power take-off (E-PTO) system, shown as E-PTO system 54, that is configured to receive electrical power from the battery pack 52 and/or other power sources and to convert the electrical power to hydraulic power for different subsystems on the refuse vehicle. In some embodiments, the E-PTO system 54 receives electrical power from the energy storage device and provides the electrical power to an electric motor 56. In such embodiments, the electric motor 56 may drive a hydraulic pump 58 that provides pressurized hydraulic fluid to different vehicle subsystems, such as the lift assembly 40, the packer/ejector, shown as ejector 62, or other subsystems (e.g., the tailgate, etc.).

The E-PTO system may include an E-PTO controller 64. The E-PTO controller 64 may monitor various systems within the refuse vehicle 10, including the E-PTO system 54. The E-PTO controller 64 may receive data from sensors within the system, compare the data to expected values under normal operating conditions, adjust the operation parameters of components of the system, and determine if a critical operating condition exists based on the sensor data. Further, the E-PTO controller 64 may shut down the system and/or the refuse vehicle 10 in response to detecting a critical operating condition. In some embodiments, the refuse vehicle 10 further includes a disconnect 66 positioned between the battery pack 52 and the E-PTO system 54 to allow different vehicle subsystems (e.g., the ejector 62, the lift assembly 40, etc.) to be decoupled and de-energized from the electrical power source. For example, the E-PTO controller 64 may cause the disconnect 66 to be decoupled and de-energized from the electrical power source.

The controller 64 may include a processor and memory. The processor may be a general purpose or specific purpose processor, an application specific integrated circuit (ASIC), one or more field programmable gate arrays (FPGAs), a group of processing components, or other suitable processing components. The processor is configured to execute computer code or instructions stored in memory or received from other computer readable media (e.g., CDROM, network storage, a remote server, etc.).

The memory may include one or more devices (e.g., memory units, memory devices, storage devices, etc.) for storing data and/or computer code for completing and/or facilitating the various processes described in the present disclosure. The memory may include random access memory (RAM), read-only memory (ROM), hard drive storage, temporary storage, non-volatile memory, flash memory, optical memory, or any other suitable memory for storing software objects and/or computer instructions. The memory may include database components, object code components, script components, or any other type of information structure for supporting the various activities and information structures described in the present disclosure. The memory may be communicably connected to the processor via the controller 64 and may include computer code for executing (e.g., by the processor) one or more processes described herein. When the processor executes instructions stored in the memory for completing the various activities described herein, the processor generally configures controller 64 to complete such activities.

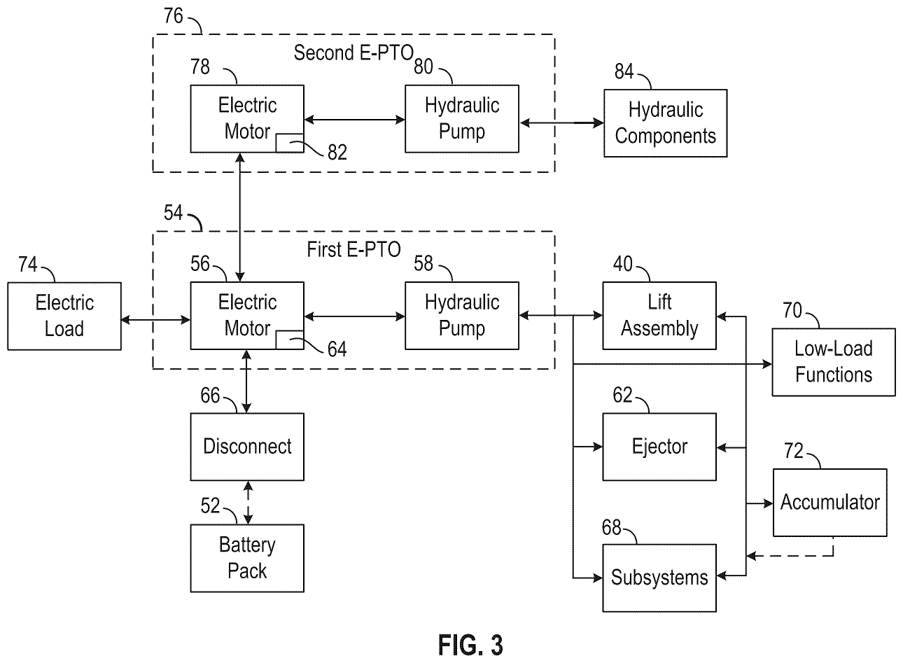

Referring to FIG. 3, in some embodiments the E-PTO controller 64 may monitor various systems within the refuse vehicle 10 and controller the systems, including the E-PTO system 54, to harvest return energy from one system for use with another system. In such embodiments, the controller 64 may operate the hydraulic pump 58 in reverse, such that a pressurized hydraulic flow (e.g., a return flow) is provided to the hydraulic pump 58 which may drive the electric motor 56. The pressurized hydraulic flow may be return flow from hydraulic components of the refuse vehicle 10 (e.g., lift assembly 40, ejector 62, subsystems 68, etc.). Beneficially, the return flow from operating one or more hydraulic components of the refuse vehicle 10 may be at a sufficient pressure to drive the hydraulic pump 58 in reverse even after being used to operate the one or more hydraulic components. In some embodiments, the return flow may be due to gravity acting on a hydraulic component to move the hydraulic component from one position or state into another position or state, wherein the return flow captures at least partially the change in potential energy due to gravity of the hydraulic component. In some embodiments, the controller 64 applies an electric load, shown as electric load 74, to the electric motor 56 (now operating as an electric generator) and the electric motor 56 creates a current (i.e., return energy) and provides the return energy to the electric load 74. As used herein, the terms motor and electric motor refer to motor/generators that can both convert electricity into mechanical energy and generate electricity from mechanical energy. The electric load 74 may include one or more systems or subsystems of the refuse vehicle 10. In some embodiments, the electric load 74 is a function (e.g., heat management system or component (e.g., a heater coil) that is not time-critical or is non-essential and can be operated at scheduled or optimized times for efficiency. For example, the electric load 74 may include a heat management system (e.g., liquid cooling, heat exchanger, air cooling, etc.) or a component of a heat management system or a coolant pump, amongst other components or functions.

Still referring to FIG. 3, in some embodiments, the controller 64 may apply a second E-PTO, shown as second E-PTO 76, as an electric load to the electric motor 56 to receive the harvested return energy. In such embodiments, the harvested return energy from a first hydraulic circuit connected to the first E-PTO 54 may be used to generate return energy which is transferred to the second E-PTO 76 to operate a second hydraulic circuit coupled to the second E-PTO 76 that is separate and independent from the first hydraulic circuit. In such embodiments, the second E-PTO 76 receives the return energy from the first E-PTO 54 and provides the return energy to the electric motor 78. The electric motor 78 may drive a hydraulic pump 80 that provides pressurized hydraulic fluid to different hydraulic components 84, which may include systems or subsystems such as the lift assembly 40, the packer/ejector, shown as ejector 62, or other subsystems (e.g., the tailgate, etc.). The second E-PTO 76 can therefore operate a separate auxiliary function using the return energy of the first function (e.g., operating the lift assembly 40), thereby conserving energy that would otherwise be wasted.

In some embodiments, the harvest return energy is provide to the electric load (e.g., electric load 74, second E-PTO 76) without the return energy passing through an onboard energy storage device such as battery pack 52. In such embodiments, the return energy may be routed directly to the electric load. Beneficially, by providing the return energy to an electric load without passing the return energy through an onboard storage device, conversion losses are reduced and the electrical connections of the refuse vehicle 10 may be simplified or reduced.

In some embodiments, the second E-PTO 76 may include a second E-PTO controller 82. The second E-PTO controller 82 may monitor various systems within the refuse vehicle 10, including the second E-PTO 76. The second E-PTO controller 82 may operate in conjunction with or independent from the first E-PTO controller 64. In some embodiments, there is a single E-PTO controller or vehicle controller that performs the functions described herein of both the first E-PTO controller 64 and the second E-PTO controller 82.

In some embodiments, the first E-PTO 54 may selectively provide return energy at least one of the electric load 74 or the second E-PTO 76, or to both. In some embodiments, the return energy is supplemented by additional energy from an onboard storage device (e.g., battery pack 52).

While the first E-PTO 54 is described as acting as an energy harvesting system to power the second E-PTO 76, in some embodiments the second E-PTO 76 can additionally and/or alternatively be an energy harvesting system to harvest return energy from a return flow from the hydraulic components 84 and generate return energy (e.g., electricity) that is provided to the first E-PTO 54.

In some embodiments, the controller 64 and/or the controller 82 may harvest return energy from one or more hydraulic components by redirecting a return flow from one hydraulic component to another hydraulic component. For example, return flow from the lift assembly 40 may be diverted to the low-load functions 70. The return flow may be sufficient to entirely power the low-load functions 70. In some embodiments, the return flow may be supplemented by additional flow from the hydraulic pump 58. In some embodiments, the return flow may be diverted to an accumulator 72. The accumulator 72 may store pressurized hydraulic fluid as a reservoir to maintain system pressure or selectively provide additional fluid flow as required. The controller 64 may control one or more valves included in each component in the hydraulic circuit (e.g., the hydraulic pump 58, the lift assembly 40, the ejector 62, the subsystems 68, the low-load functions 70, the accumulator 72, etc.) to control where a return flow of the hydraulic system is directed to. For example, as shown in FIG. 3, the hydraulic pump 58 is coupled to the lift assembly 40 and may provide hydraulic fluid to the lift assembly 40 to operate the lift assembly 40. The lift assembly 40 may, for example, be transitioned from a first position or state to a second position or state. The second position or state may have a higher potential energy (i.e., a raised position) as compared to the first position or state (i.e., a lowered position). In some embodiments, the controller 64 may direct the lift assembly 40 to return to the first position from the second position. While returning to the first position, the change in potential energy may result in a return flow of hydraulic fluid. The controller 64 may operate the one or more valves of the hydraulic components in the circuit to provide return flow to the ejector 62. In some embodiments, the flow is sufficient for at least a first stroke of ejector 62. In such embodiments, after operating the lift assembly 40 to dump refuse in the refuse compartment 30, the controller 64 harvests return energy such that the ejector 62 may compact or at least partially compact the refuse using the return energy from lifting the refuse into the refuse compartment 30 in the first instance. In some embodiments, the controller 64 may direct the return flow first to the accumulator 72. The flow from the accumulator 72 may then be used to operate one or more hydraulic components of the refuse vehicle (e.g., the ejector 62, the subsystems 68, etc.) The hydraulic flow and the return flow from each component in the system may therefore be individually controllable by the operation of one or more valves in each hydraulic component to allow a controller (e.g., controller 64) to direct the flow of hydraulic fluid both to and from components.

In some embodiments, the return flow is directed to the low-load functions 70. The low-load functions 70 may be functions with a reduced pressure requirement relative to other functions or components of the system. In some embodiments, low-load functions 70 require less than or equal to 90% of the hydraulic pressure of another component of the refuse vehicle. In some embodiments, low-load functions 70 require less than or equal to 75% of the hydraulic pressure of another component of the refuse vehicle. In some embodiments, low-load functions 70 require less than or equal to 50% of the hydraulic pressure of another component of the refuse vehicle. In some embodiments, low-load functions 70 require 1%-50% of the hydraulic pressure of another component of the refuse vehicle. The low-load functions 70 may include lubrication systems, cooling systems, or other functions/components that require less force and pressure to function.

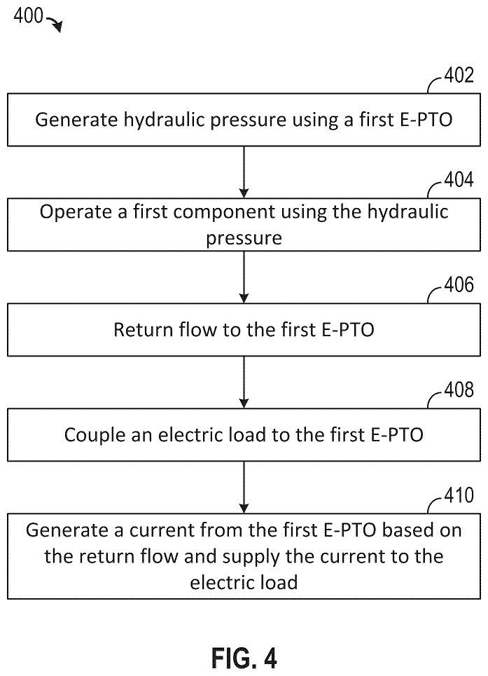

Referring now to FIG. 4, a process 400 of harvesting return energy using an E-PTO as an energy harvesting system is shown, according to an exemplary embodiment. The process 400 can be performed by one or more controllers of a refuse vehicle 10 (e.g., controller 64, controller 82, etc.). The process 400 begins at step 402, where hydraulic pressure is generated by a first E-PTO. In some embodiments, step 402 includes operating the first E-PTO 54. The first E-PTO may generate the hydraulic pressure by using an electric motor drawing power from an onboard storage device (e.g., batteries, ultra-capacitors, etc.), an onboard generator (e.g., an internal combustion engine, hydrogen fuel cells, high efficiency solar panels, regenerative braking system, etc.), or from an external power source (e.g., overhead power lines) to operate a hydraulic pump (e.g., hydraulic pump 58) and generate the hydraulic pressure.

At step 404, the controller operates a first component using the hydraulic pressure. The first component is fluidly coupled to a hydraulic pump of the first E-PTO. In some embodiments, the first component may be a lift assembly such as lift assembly 40, an ejector such as ejector 62, or any other hydraulically actuated system or subsystem of the refuse vehicle 10. In operation of the first component, an input flow at a first hydraulic pressure is received by the first component and an output or return flow at a second hydraulic pressure is output by the first component. In some embodiments, multiple components may be operated in step 404 by the hydraulic pressure.

At step 406, the output or return flow from the first component is diverted back to the first E-PTO. In some embodiments, one or more independently operable valves may be positioned between the first component and the E-PTO. In some embodiments, the E-PTO and each hydraulic component coupled to the E-PTO include their own one or more valves. A controller (e.g., controller 64, controller 82) may control the one or more valves to direct the return flow from the first component to the first E-PTO.

At step 408, an electric load is coupled to the first E-PTO. In some embodiments, the electric load is coupled or electrically coupled to an electric motor that is a part of the first E- PTO (e.g., motor 56). In some embodiments, the electric load may be the same or similar to electric load 74. In some embodiments, the electric load may additionally and/or alternatively include another E-PTO, such as the second E-PTO 76. By coupling an electric load to the electric motor, the electric motor may act as a generator for converting mechanical energy to electricity.

At step 410, the first E-PTO generates a current based on the return flow and supplies the current (i.e., the harvested return energy) to the electric load. For example, in embodiments where the electric load is an electric component such as a heater circuit or a coolant pump, the return energy may be provided to operate or at least partially operate the heater circuit or coolant pump. In other embodiments where the electric load is another E-PTO (e.g., the second E-PTO 76) the harvested return energy may be provided to the E-PTO to operate one or more other hydraulic components. In such embodiments, the energy in the return flow of one hydraulic system (e.g., coupled to a first E-PTO) can be harvested/recapture and transferred to another hydraulic system (e.g., coupled to the second E-PTO).

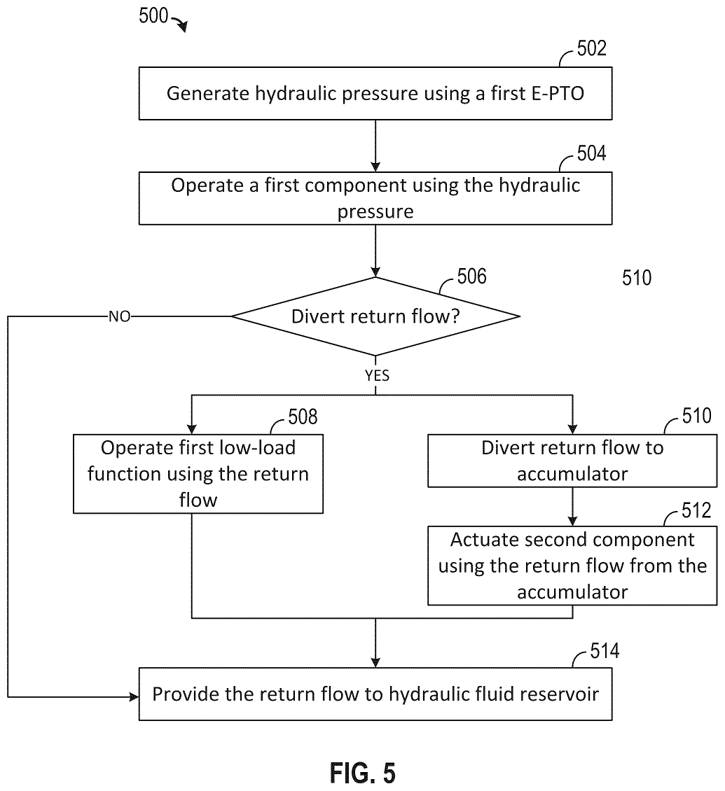

Referring now to FIG. 5, a process 500 of harvesting return energy using one or more valves is shown, according to an exemplary embodiment. The process 500 can be performed by one or more components of the refuse vehicle 10 (e.g., controller 64, controller 82, the first E-PTO 54, the lift assembly 40, etc.). The process 500 begins at step 502, where hydraulic pressure is generated by a first E-PTO. In some embodiments, step 502 includes operating the first E-PTO 54. The first E-PTO may generate the hydraulic pressure by using an electric motor drawing power from an onboard storage device (e.g., batteries, ultra-capacitors, etc.), an onboard generator (e.g., an internal combustion engine, hydrogen fuel cells, high efficiency solar panels, regenerative braking system, etc.), or from an external power source (e.g., overhead power lines) to operate a hydraulic pump (e.g., hydraulic pump 58) and generate the hydraulic pressure. In some embodiments, step 502 is the same or similar to step 402.

At step 504, the controller operates a first component using the hydraulic pressure. The first component is fluidly coupled to a hydraulic pump of the first E-PTO. In some embodiments, the first component may be a lift assembly such as lift assembly 40, an ejector such as ejector 62, or any other hydraulically actuated system or subsystem of the refuse vehicle 10. In operation of the first component, an input flow at a first hydraulic pressure is received by the first component and an output or return flow at a second hydraulic pressure is output by the first component. In some embodiments, multiple components may be operated in step 504 by the hydraulic pressure.

At step 506, the controller determines whether to divert the return flow from the first component. If the controller determines not to divert the return flow, the process 500 proceeds to step 514 and the return flow is provided to a hydraulic fluid reservoir. The controller may be configured to monitor the pressure of the return flow and determine not to divert the return flow at step 506 if the pressure of the return flow is below a threshold pressure value. In some embodiments, the controller may access a database stored in memory or remotely over a network which contains a minimum operating pressure for one or more components of the refuse vehicle. In some embodiments, the controller may determine not to divert the return flow at step 506 if a pressure of the return flow is below a minimum operating pressure of the one or more components of the refuse vehicle.

If the controller determines to divert the return flow, then the process 500 proceeds to either of and/or both of steps 508 and 510. In some embodiments, the controller determines to divert the return flow if a pressure of the return flow is at or above a predetermined threshold or at or above a minimum operating pressure for one or more components of the refuse vehicle. In some embodiments, the controller determines to divert the return flow if a pressure of the return flow I in addition to supplemental flow from a hydraulic pump (e.g., hydraulic pump 58, 80) is at or above a predetermined threshold or at or above a minimum operating pressure for one or more components of the refuse vehicle.

In some embodiments, the process 500 proceeds to step 508 and/or step 510. The controller may be configured to operate one or more valves to determine where to divert a return flow to. At step 508, at least a part of the return flow is diverted to operate a low-load function using the return flow or a part thereof. The low-load function may be a non-critical function (or component) that can be run at selective, optimal times (e.g., one or more components of a heat management system, a coolant pump, etc.). In some embodiments, the low-load functions may be the same or similar to low-load functions 70. The low-load functions may be functions with a reduced pressure requirement relative to other functions or components of the system. In some embodiments, the low-load functions require less than or equal to 90% of the hydraulic pressure of another component of the refuse vehicle. In some embodiments, the low-load functions \ require less than or equal to 75% of the hydraulic pressure of another component of the refuse vehicle. In some embodiments, the low-load functions require less than or equal to 50% of the hydraulic pressure of another component of the refuse vehicle. In some embodiments, lthe ow-load functions require 1%-50% of the hydraulic pressure of another component of the refuse vehicle. The low-load functions may include lubrication systems, cooling systems, or other functions/components that require less force and pressure to function.

In some embodiments, the process 500 proceeds to step 510. At step 510, the return flow is diverted to an accumulator. The accumulator may store pressurized hydraulic fluid as a reservoir to maintain system pressure or selectively provide additional fluid flow as required (i.e., an onboard storage device). After step 510 the process 500 advances to step 512. At step 512 the return flow in the accumulator may be used to actuate a second component. In some embodiments, the return flow may be used to power a plurality of other components of the refuse vehicle. At step 514, the return flow hydraulic fluid is returned to a hydraulic fluid reservoir.

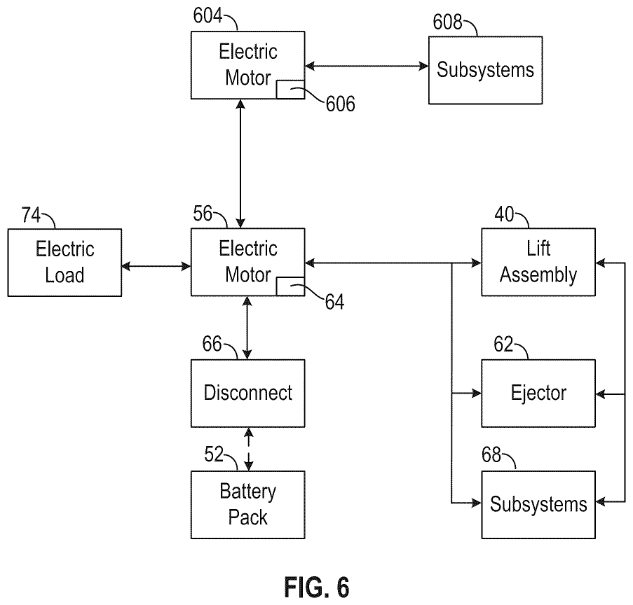

Referring now to FIG. 6, in embodiments in which the refuse vehicle is an electric refuse vehicle or a hybrid refuse vehicle, the refuse vehicle may include an energy harvesting system that includes the electric motor 56 and/or a second electric motor show as electric motor 604. The components and arrangement of components in FIG. 6 may be in addition or supplemental to the components shown in FIG. 3. For example, a refuse vehicle 10 may include both a second E-PTO 76 coupled to the electric motor 56 and the electric motor 604 coupled to the electric motor 56.

In some embodiments, the E-PTO controller 64 may monitor various systems within the refuse vehicle 10 and controller the systems, including the electric motor 56 and/or the electric motor 604 (in conjunction or independently of controller 606), to harvest return energy from electrically operated system for use with another electrically operated system. In such embodiments, the controller 64 may configure the electric motor 56 to resist or slow the movement of one or more components and thereby generate an electric current. For example, the electric motor 56 may be configured in a first instance to draw power from an onboard energy storage device such as battery pack 52 and raise a lift assembly 40 from a first position to a second position, before in a second instance being configured to resist or slow the movement of lift assembly from the second position back to the first position. In resisting or slowing the movement of the lift assembly 40 from one position to another position, the electric motor 56 may act as a generator to generate an electric current once an electric load is applied to the electric motor 56. In such embodiments, the electric load may be the electric load 74 and/or the electric motor 604. In some embodiments, the electric motor 604 is configured to operate other subsystems 608 using the harvested return energy.

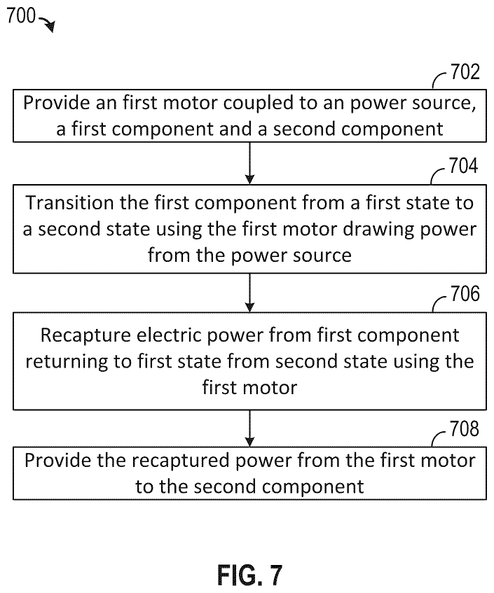

Referring now to FIG. 7, a process 700 for harvesting return energy from electrically operated components is shown, according to an exemplary embodiment. The process 700 can be performed by one or more controllers of a refuse vehicle 10 (e.g., controller 64, controller 606, etc.). The process 700 begins at step 702, with providing an first motor coupled to a power source, a first component and a second component. The power source may be an onboard storage device (e.g., batteries, ultra-capacitors, etc.), an onboard generator (e.g., an internal combustion engine, hydrogen fuel cells, high efficiency solar panels, regenerative braking system, etc.), or an external power source (e.g., overhead power lines). The first component may be an electrically actuated component such as a lift assembly 40, an ejector 62, and/or subsystems 68. It should be understood that the lift assembly 40, an ejector 62, and/or subsystems 68 may be hydraulic or electric. In such embodiments that the lift assembly 40, an ejector 62, and/or subsystems 68 are electric they may make up the first component or the second component. In some embodiments, the second component may be an electric load such as electric load 74, a second electric motor such as electric motor 604, or one or more other electrically operated components of the refuse vehicle 10.

Step 704 includes transitioning a first component from a first state to a second state. In some embodiments the first state is a first position and the second state is a second position offset from the first position, and step 704 includes actuating the first component from the first position to the second position. For example, the first component may be a lift assembly 40, and the first position may be a lowered position and the second position may be a raised position. The first component is transitioned from the first state to the second state by the first motor with power from the power source.

At step 706, electric power is recaptured from the first component returning to the first state from the second state using the first motor. The recaptured electric power is otherwise referred to as harvested return energy. In some embodiments, motor is coupled to the first component and configured to slow or resist movement of the first component. For example, the motor may resist a lift assembly 40 as it transitions from a second raised position back to a first lowered position. By resisting the movement of the lift assembly 40, the motor, once coupled to an electric load, produces an electric current that compromises the recaptured or harvested return energy.

At step 708, the recaptured power (i.e., harvested return energy) is provide from the first motor to the second component. In some embodiments, the second component is an electric load coupled to the first motor such as electric load 74. In some embodiments, the second component is an electric load such as the electric motor 604 coupled to the first motor. In some embodiments, the recaptured power is provided to the second component without the recaptured power passing through or being temporarily contained in the onboard energy storage device. In some embodiments, the recaptured power is provided directly to the second component. Beneficially, by providing the recaptured power to an second component without passing the return energy through an onboard storage device, conversion losses are reduced and the electrical connections of the refuse vehicle 10 may be simplified or reduced.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members, or the two members and any additional intermediate members being integrally formed as a single unitary body with one another or with the two members or the two members and any additional intermediate members being attached to one another.

References herein to the positions of elements (e.g., “top,” “bottom,” “above,” etc.) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the refuse vehicle as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present disclosures. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A refuse vehicle, comprising:
a chassis;
a body assembly coupled to the chassis, the body assembly defining a refuse compartment for storing refuse therein;
an energy storage system supported by the chassis;
an energy harvesting system coupled to the energy storage system;
a first component coupled to the energy harvesting system;
a second component coupled to the energy harvesting system;
wherein the energy harvesting system is configured to:
operate the first component to transition from a first state to a second state using energy from the energy storage system;
harvest return energy from the first component returning to the first state from the second state; and
operate the second component using the return energy.

2. The refuse vehicle of claim 1, wherein the energy harvesting system is further configured to operate the second component using the return energy without the return energy passing through the energy storage system.

3. The refuse vehicle of claim 2, wherein the energy storage system is an electrical energy storage system and wherein the energy harvesting system comprises an electric motor/generator configured to operate the first component, harvest the return energy, and operate the second component.

4. The refuse vehicle of claim 3, wherein harvest the return energy comprises regenerating electrical energy from the first component returning to the first state from the second state.

5. The refuse vehicle of claim 3, wherein the electric motor/generator is a first electric motor/generator, and the second component is a second electric motor/generator configured to operate a third component using the return energy.

6. The refuse vehicle of claim 5, wherein the electrical energy storage system is a battery.

7. The refuse vehicle of claim 1, wherein the first component is a first hydraulic component, the energy storage system is an electrical energy storage system, and the energy harvesting system comprises an electric power take-off (E-PTO) configured to operate the first hydraulic component using energy from the electrical energy storage system.

8. The refuse vehicle of claim 7, wherein the E-PTO is further configured to harvest the return energy from a return hydraulic fluid flow and generate electric energy to operate the second component.

9. The refuse vehicle of claim 8, wherein the second component is a second E-PTO fluidly coupled to a third component and configured to operate the third component at least partially using the return energy.

10. The refuse vehicle of claim 7, wherein harvesting the return energy from the first component comprises diverting a return flow from the first component to the second component to operate the second component at least partially using the return flow.

11. The refuse vehicle of claim 1, wherein the second component is at least one of one or more components of a packer system, one or more components of a heating system, or one or more components of a cooling system.

12. A method of operating a refuse vehicle comprising:
receiving, by a controller of an energy harvesting system coupled to a vehicle body of a refuse vehicle, energy from an energy storage system coupled to a chassis of the refuse vehicle, the vehicle body supported by the chassis and defining a receptacle for storing refuse therein, and the energy storage system configured to provide energy to drive at least one of a plurality of wheels that are supported by the chassis;
operating, with the energy, a first component coupled to the chassis from a first state to a second state using the energy harvesting system;
harvesting return energy from the first component returning to the first state from the second state using the energy harvesting system; and
operating, with the return energy, a second component coupled to the chassis.

13. The method of claim 12, wherein the second component is at least one of one or more components of a packer system, one or more components of a heating system, or one or more components of a cooling system.

14. The method of claim 12, wherein the energy harvesting system comprises a motor/generator, the method further comprising operating the first component with the motor/generator and harvesting the return energy with the motor/generator.

15. The method of claim 14, wherein the second component is a second motor/generator, the method further comprising:
operating a third component with the second component using the return energy.

16. The method of claim 14, wherein the first component is a first hydraulic component, the energy storage system is an electric energy storage system, and the motor/generator is a first electric power take-off (E-PTO).

17. The method of claim 16, wherein the return energy is return electrical energy, the method further comprising harvesting the return energy from a return flow due to the first component returning to the first state and from the second state.

18. The method of claim 17, wherein the second component is a second E-PTO, the method further comprising:
operating a third hydraulic component with the second E-PTO using the return energy.

19. The method of claim 12, wherein the return energy does not pass through the energy storage system.

20. A refuse vehicle, comprising:
a chassis;
a body assembly coupled to the chassis, the body assembly defining a refuse compartment for storing refuse therein;
an energy storage system supported by the chassis;
an energy harvesting system coupled to the energy storage system and comprising a motor/generator;
a first component coupled to the motor/generator, wherein the first component is at least one of a first electromechanical component or a first hydraulic component;
an electric load coupled to the motor/generator;
wherein the energy harvesting system is configured to:
operate, via the motor/generator, the first component to transition from a first state to a second state using energy from the energy storage system;
resist, via the motor/generator, the first component returning to the first state from the second state to generate return energy; and
provide the return energy to the electric load, wherein the return energy does not pass through the energy storage system.
